(19) United States
(12) Patent Application Publication
(10) Pub. No.: US 2025/0149918 A1
(43) Pub. Date: May 8, 2025

(54) CHARGING SYSTEM AND METHOD

(71) Applicant: Cypress Semiconductor Corporation, San Jose, CA (US)

(72) Inventors: Tsan-Feng YAO, New Taipei City (TW); Zaiqiang Zhang, Shenzhen (CN); Chien Cheng Chih, New Taipei City (TW); Tzu Wei Liu, Keelung City (TW); Jhong Yang Wu, New Taipei City (TW); Chuan-Yu Lin, Milpitas, CA (US)

(73) Assignee: Cypress Semiconductor Corporation, San Jose, CA (US)

(21) Appl. No.: 18/608,672

(22) Filed: Mar. 18, 2024

Related U.S. Application Data
(60) Provisional application No. 63/596,154, filed on Nov. 3, 2023.

(51) Int. Cl. H02J 50/10; H02J 7/00

(52) U.S. Cl. CPC H02J 50/10; H02J 7/00032; H02J 7/00712; H02J 2207/20

(57) ABSTRACT

In an embodiment of the techniques presented herein, a charging system includes an input port, a wireless charging unit, having a magnetic charging interface, and a wireless charging controller configured to generate a magnetic charging signal at the magnetic charging interface based on a first connection state of the magnetic charging interface, and a universal serial bus power delivery (USB-PD) power adaptor, having an output port, and a USB-PD controller configured to deliver power to the output port, wherein a first portion of available power at the input port is allocated to the wireless charging unit for generating the magnetic charging signal responsive to the first connection state indicating a connected device, and a second portion of the available power at the input port is allocated to the USB-PD adaptor based on the first portion allocated to the wireless charging unit.

### RELATED APPLICATION(S)

This application claims priority to U.S. Provisional Application No. 63/596,154 filed on Nov. 3, 2023, the entirety of which is hereby incorporated by reference herein.

### BACKGROUND

Various electronic devices (e.g., such as smartphones, tablets, notebook computers, laptop computers, hubs, chargers, adapters, etc.) are configured to transfer power through Universal Serial Bus (USB) connectors according to USB power delivery protocols defined in various revisions of the USB Power Delivery (USB-PD) specification. Some devices also support wireless charging defined in various specifications.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a charging system comprises an input port, a wireless charging unit, comprising a magnetic charging interface, and a wireless charging controller configured to generate a magnetic charging signal at the magnetic charging interface based on a first connection state of the magnetic charging interface, and a universal serial bus power delivery (USB-PD) power adaptor, comprising an output port, and a USB-PD controller configured to deliver power to the output port, wherein a first portion of available power at the input port is allocated to the wireless charging unit for generating the magnetic charging signal responsive to the first connection state indicating a connected device, and a second portion of the available power at the input port is allocated to the USB-PD adaptor based on the first portion allocated to the wireless charging unit.

In an embodiment of the techniques presented herein, a system comprises means for receiving a power supply signal at an input port, means for generating a magnetic charging signal at a magnetic charging interface based on a first connection state of the magnetic charging interface, means for delivering power to a universal serial bus (USB) output port, means for allocating a first portion of available power at the input port for generating the magnetic charging signal responsive to the first connection state indicating a connected device, wherein the available power at the input port is a function of the power supply signal, and allocating a second portion of the available power at the input port for delivering the power to the USB output port based on the first portion allocated for generating the magnetic charging signal.

In an embodiment of the techniques presented herein, a method for operating a charging system comprises receiving a power supply signal at an input port, generating a magnetic charging signal at a magnetic charging interface based on a first connection state of the magnetic charging interface, delivering power to a universal serial bus (USB) output port, allocating a first portion of available power at the input port for generating the magnetic charging signal responsive to the first connection state indicating a connected device, wherein the available power at the input port is a function of the power supply signal, and allocating a second portion of the available power at the input port for delivering the power to the USB output port based on the first portion allocated for generating the magnetic charging signal.

In an embodiment of the techniques presented herein, a charging system comprises an input port, a wireless charging unit, comprising a magnetic charging interface, and a wireless charging controller configured to generate a magnetic charging signal at the magnetic charging interface based on a first contract, and a universal serial bus power delivery (USB-PD) power adaptor, comprising an output port, and a USB-PD controller configured to deliver power to the output port based on a second contract, wherein one of the wireless charging controller or USB-PD controller is designated as a primary controller and the other of the wireless charging controller or USB-PD controller is designated as a secondary controller, the primary controller is configured to generate a power delivery profile for the USB-PD controller based on available power at the input port and power used by the wireless charging unit to generate the magnetic charging signal according to the first contract, and the secondary controller is configured send an interrupt signal to the primary controller responsive to a change in a connection state associated with the secondary controller.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram of a charging system including a wireless charging unit and a universal serial bus (USB) power delivery (USB-PD) adaptor, in accordance with some embodiments.

FIG. 2 is a flowchart illustrating a method of operating a charging system, in accordance with some embodiments.

FIG. 3 is a block diagram of a charging system operating in a power delivery mode, in accordance with some embodiments.

FIG. 4 is a block diagram of a charging system operating in a wireless charging mode and a power delivery mode, in accordance with some embodiments.

FIG. 5 illustrates an exemplary embodiment of a system, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

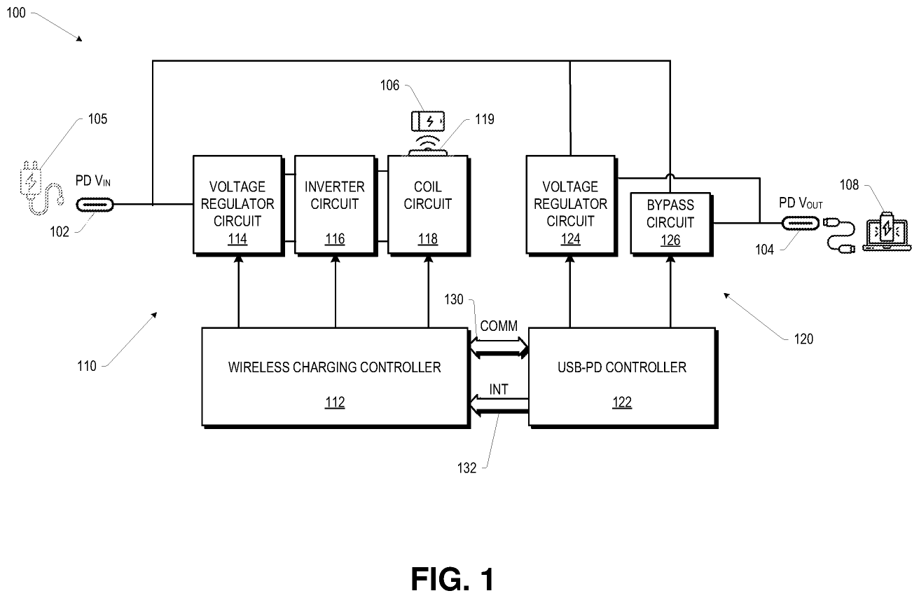

FIG. 1 is a block diagram illustrating a charging system 100 including a universal serial bus (USB) input port 102, at least one USB output port 104, a wireless charging unit 110, and a USB power delivery (USB-PD) adaptor 120, in accordance with some embodiments. In some embodiments, the charging system 100 may request a PD VIN voltage from a power source providing power at the USB input port 102, such as a USB-PD adaptor 105.

In some embodiments, the wireless charging unit 110 comprises a wireless charging controller 112 (WLC), a voltage regulator circuit 114, such as a buck regulator circuit, an inverter circuit 116, and a coil circuit 118. In some embodiments, the wireless charging controller 112 controls the voltage regulator circuit 114 to generate a DC voltage from a PD VIN voltage received at the USB input port 102. The inverter circuit 116 generates an AC voltage for powering the coil circuit 118. The coil circuit 118 generates a magnetic signal for charging a device equipped with wireless charging capability (RX device 106), such as a laptop, a smart phone, a tablet, or some other device, typically including a rechargeable battery. The RX device 106 may be placed on magnetic charging interface 119, such as a charging pad, on a charging mat, near a beamforming device, or by some other magnetic charging interface to receive the magnetic charging signal. In some instances, the PD VIN voltage may be higher than the voltage required by the wireless charging unit 110. The voltage regulator circuit 114 may be operated by the wireless charging controller 112 in a buck mode to step down the input voltage.

In some embodiments, the USB-PD adaptor 120 comprises a USB-PD controller 122, a voltage regulator circuit 124, such as a buck regulator circuit, and an optional bypass circuit 126. Any number of USB output ports 104 may be provided. The USB output port 104 is connected to provide an output voltage, PD VOUT, to a connected device (PD device 108), such as a laptop, a smart phone, a tablet, or some other device, typically including a rechargeable battery. The USB-PD controller 122 controls the voltage regulator circuit 124 to deliver power to the USB output port 104 from the PD VIN voltage received at the USB input port 102. In some instances, the PD VIN voltage may be higher than the voltage required by the USB-PD adaptor 120. The voltage regulator circuit 124 may be operated by the USB-PD controller 122 in a buck mode to step down the input voltage. In a situation where the PD VIN voltage is the same as required for powering the PD device 108, the USB-PD adaptor 120 may disable the voltage regulator circuit 124 and enable the bypass circuit 126 and pass the PD V_{IN} voltage at the USB input port 102 to the USB output port 104 to generate the PD V_{OUT} voltage.

In some embodiments, the wireless charging controller 112 and the USB-PD controller 122 communicate using a communication bus 130 and an interrupt line 132 to exchange changes in connection states or charging profiles. The communication bus 130 may be a serial bus, such as an 12C bus, an SPI bus, or a UART bus. One of the wireless charging controller 112 and the USB-PD controller 122 is designated as a primary controller and the other is designated as a secondary controller. The secondary controller sends a signal on the interrupt line 132 to indicate a change in connection state to the primary controller. In the embodiment illustrated in FIG. 1, the wireless charging controller 112 is designated as the primary controller, the USB-PD controller 122 is designated as the secondary controller, and the USB-PD controller 122 sends interrupt signals on the interrupt line 132. In an alternative embodiment, the USB-PD controller 122 could be the primary and the secondary wireless charging controller 112 would send interrupts on the interrupt line 132.

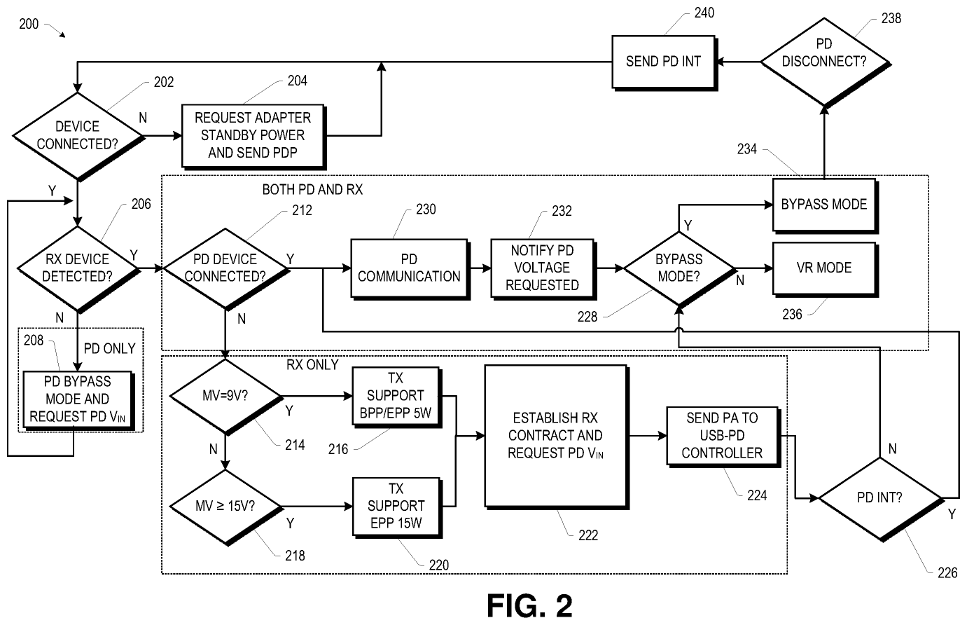

FIG. 2 is a flowchart illustrating a method 200 of operating the charging system 100, in accordance with some embodiments. At 202 the wireless charging controller 112 and the USB-PD controller 122 communicate connection states to determine if any devices are connected (e.g., wireless RX device 106 or USB-PD device 108). In some embodiments, the wireless charging controller 112 identifies if the RX device 106 is connected based on the connection state of the magnetic charging interface 119 and the USB-PD controller 122 determines if the PD device 108 is connected based on the connection state of the USB output port 104. The wireless charging controller 112 may assume that no PD device 108 is connected to the USB output port 104 unless an interrupt was previously received from the USB-PD controller 122 on the interrupt line 132. If no device is connected to the charging system 100 at 202, the wireless charging controller 112 requests a standby power level (e.g., 5V) for the PD V_{IN} voltage from the USB-PD adaptor 105 and sends a power delivery profile (PDP) to the USB-PD controller 122 based on the available power of the USB-PD adaptor 105 at 204.

If a RX device 106 is not connected at 206 (i.e., only the PD device 108 is connected), the USB-PD controller 122 enables the bypass circuit 126 at 208 to connect the voltage at the USB input port 102 to the USB output port 104 and returns to 206 to detect connected RX devices 106. The voltage requested from the USB-PD adaptor 105 for PD V_{IN} is set at the voltage requested by the PD device 108.

If the RX is connected at 206, the wireless charging controller 112 determines if the PD device 108 is connected to the USB output port 104 at 212 (e.g., based on an interrupt signal on the interrupt line 132). If the PD device 108 is not connected at 212 (i.e., only RX device 106 connected), the wireless charging controller 112 determines the maximum voltage (MV) for the USB-PD adaptor 105, and if the max voltage is 9V at 214, the wireless charging controller 112 sets a configuration register to indicate TX support for a baseband power profile (BPP) or an extended power profile (EPP) of 5 W at 216. If the max voltage is greater than 9V at 214 and the maximum voltage is greater than or equal to 15V at 218, the wireless charging controller 112 sets a configuration register to indicate TX support for an EPP of 15 W at 220. Based on the TX profile set at 216 or 220, the wireless charging controller 112 establishes a RX contract with the RX device 106 and requests a corresponding PD V_{IN} voltage from the USB-PD adaptor 105 at 222. At 224, the wireless charging controller 112 sends a message indicating power available for allocating by the USB-PD controller 122 over the communication bus 130 that could be allocated by the USB-PD controller 122 if the PD device 108 were to be connected. For example, if the RX device 106 is not connected the power available would be the maximum amount that could be provided by the USB-PD adaptor 105. If the RX device 106 is connected the power available for allocation by the USB-PD controller 122 would be the power available at the USB input port 102 as provided by the USB-PD adaptor 105 minus a first portion of the available power allocated to the wireless charging controller 112 for charging the RX device 106 at the magnetic charging interface 119.

A power delivery profile (PDP) is generated based on the portion of the available power allocated to the USB-PD controller 122. The PDP may be generated by the wireless charging controller 112 and communicated to the USB-PD controller 122 over the communication bus 130, or the USB-PD controller 122 may determine the PDP based on the portion of the available power allocated to the USB-PD controller 122. The PDP specifies various voltage levels and current levels supported by the USB-PD controller 122 to establish a contract with the PD device 108.

Connection of a PD device 108 is detected by the wireless charging controller 112 at 226 based on a PD INT signal generated by the USB-PD controller 122 on the interrupt line 132. If no PD INT is generated at 226, the USB-PD controller 122 determines if bypass mode should be enabled at 228.

If the PD device 108 is connected at 212 (i.e., both RX device 106 and PD device 108 connected), the wireless charging controller 112 instructs the USB-PD controller 122 to communicate with the PD device 108 to establish a power delivery contract based on the PDP at 230. The USB-PD controller 122 communicates the PD voltage requested according the power delivery contract to the wireless charging controller 112 at 232 (i.e., over the communication bus 130). The USB-PD controller 122 determines the bypass mode at 228 based on PD V_{IN} and the requested voltage. If the PD requested voltage matches PD V_{IN}, the USB-PD controller 122 enables bypass mode at 234 (i.e., by enabling the bypass circuit 126). If the PD requested voltage is less than PD V_{IN}, the USB-PD controller 122 enables voltage regulation (VR) mode at 236 (i.e., by enabling the voltage regulator circuit 124 to step down the PD V_{IN} voltage to generate the PD requested voltage).

The USB-PD controller 122 detects a disconnection of the PD device 108 from the USB output port 104 at 238. Responsive to the disconnection, the USB-PD controller 122 sends an interrupt at 240 and the method returns to 202. The wireless charging controller 112 dynamically updates the PDP for the USB-PD controller 122 as connection states change for the RX device 106 or the PD device 108.

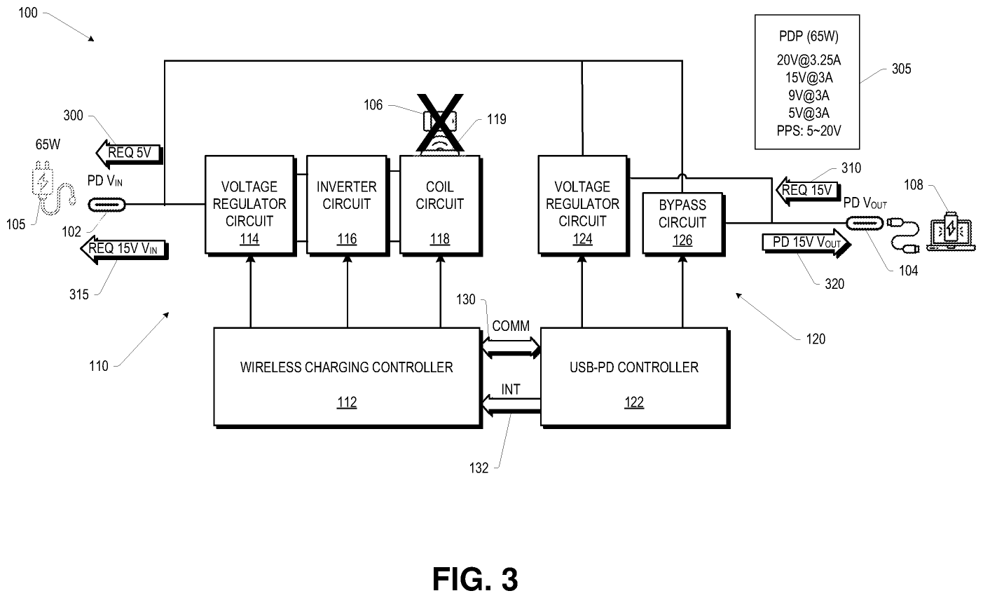

FIG. 3 is a block diagram of the charging system 100 operating in a power delivery mode, in accordance with some embodiments. In the example of FIG. 3, a PD device 108 is connected to the USB output port 104, but no RX device 106 is connected to the magnetic charging interface 119. The example of FIG. 3 is described with reference to the method 200 of FIG. 2. Prior to connection of the PD device 108, the wireless charging controller 112 sends a request 300 to the USB-PD adaptor 105 for an initial voltage for the PD V_{IN} voltage of 5V and sends a PDP 305 to the USB-PD controller 122 over the communication bus 130 at 204. In the illustrated example, the USB-PD adaptor 105 can provide 65 W. The PDP 305 specifies the following available profiles:
20V @ 3.25 A
15V @ 3 A
9V @ 3 A
5V @ 3 A
PPS: 5˜20V

The USB-PD controller 122 detects the connection of the PD device 108 at the USB output port 104 at 202 and 206 and sends an interrupt in the interrupt line 132 to the wireless charging controller 112. The USB-PD controller 122 communicates with the PD device 108 at 208 to establish a PD contract. Assume the PD device 108 sends a request 310 for 15V to the USB-PD controller 122 for the PD contract. The USB-PD controller 122 communicates the PD voltage requested to the wireless charging controller 112 over the communication bus 130. The wireless charging controller 112 sends a request 315 to the USB-PD adaptor 105 for 15V. The USB-PD controller 122 enables the bypass circuit 126 to bypass the voltage regulator circuit 124 at 234 since PD V_{IN} matches PD V_{OUT}.

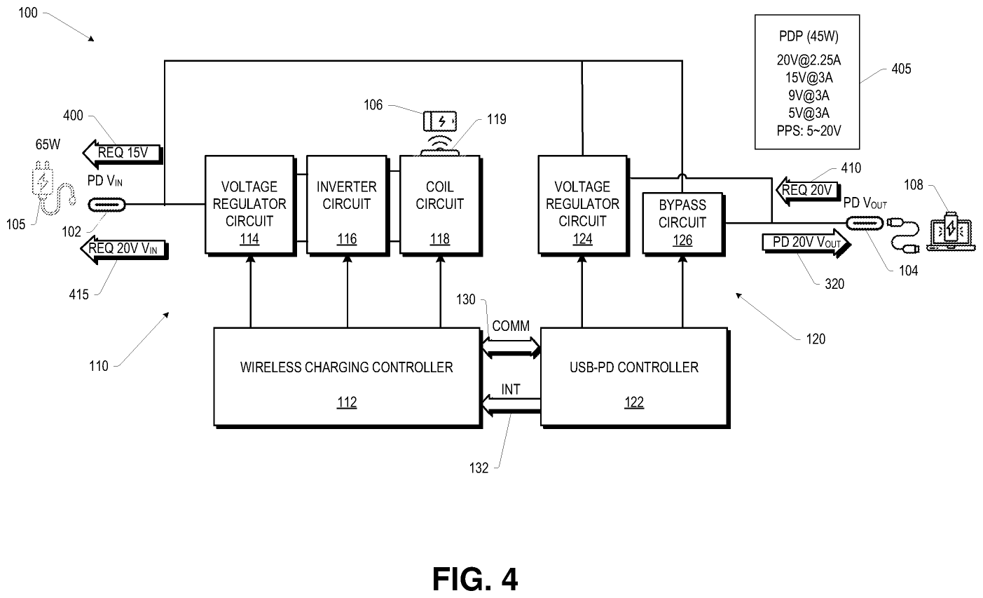

FIG. 4 is a block diagram of the charging system 100 operating in a wireless charging mode and a power delivery mode, in accordance with some embodiments. In the example of FIG. 4, an RX device 106 is connected to the magnetic charging interface 119 and the PD device 108 is subsequently connected to the USB output port 104. The example of FIG. 4 is described with reference to the method 200 of FIG. 2. Assume the RX device 106 supports 15V at 220. Prior to connection of the PD device 108, the wireless charging controller 112 establishes an RX contract (15V, 15 W) with the RX device 106 at 222 and sends a request 400 to the USB-PD adaptor 105 for an initial voltage for the PD V_{IN} voltage of 15V. The wireless charging controller 112 sends a PDP 405 to the USB-PD controller 122 over the communication bus 130 at 224 based on an available power of 45 W. The PDP 405 specifies the following available profiles:
20V @ 2.25 A
15V @ 3 A
9V @ 3 A
5V @ 3 A
PPS: 5˜20V

The USB-PD controller 122 detects the connection of the PD device 108 at the USB output port 104 and sends an interrupt in the interrupt line 132 to the wireless charging controller 112 at 226. The USB-PD controller 122 communicates with the PD device 108 at 230 to establish a PD contract. Assume the PD device 108 sends a request 410 for 20V to the USB-PD controller 122 for the PD contract. The USB-PD controller 122 communicates the PD voltage requested to the wireless charging controller 112 over the communication bus 130 at 232. The wireless charging controller 112 sends a request 415 to the USB-PD adaptor 105 for 20V. The wireless charging controller 112 controls the voltage regulator circuit 114 to step down the voltage from 20V to 15V to power the inverter circuit 116. The USB-PD controller 122 enables the bypass circuit 126 to bypass the voltage regulator circuit 114 at 234 since PD V_{IN} (20V) matches the requested voltage for PD V_{OUT}.

Communication between the wireless charging controller 112 and the USB-PD controller 122 facilitates efficient allocation of power in the charging system 100. Power delivery profiles can be updated dynamically as different RX devices 106 and PD devices 108 are connected and disconnected.

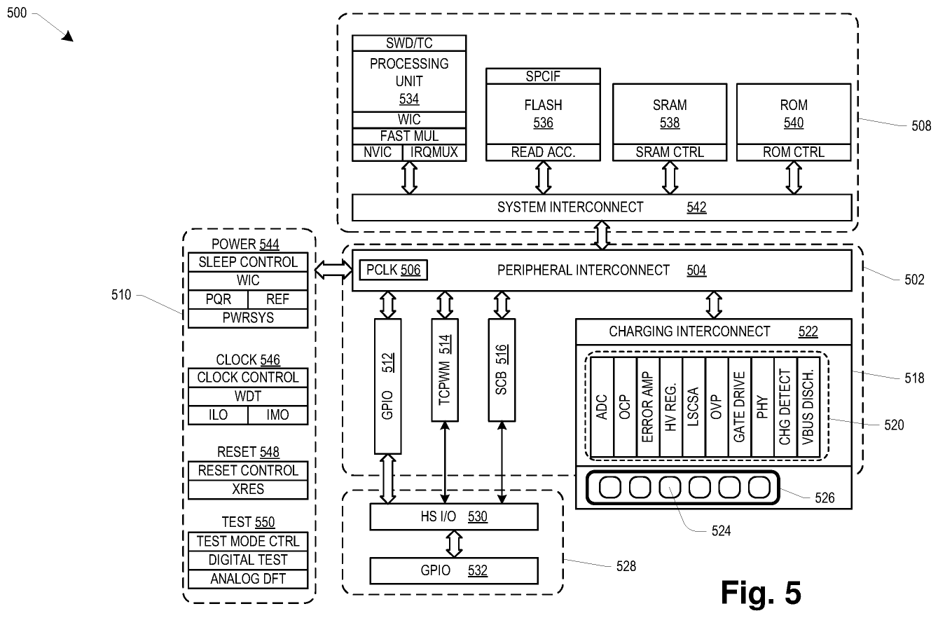

FIG. 5 is a block diagram illustrating a system 500, in accordance with some embodiments. The system 500 may be used to implement the wireless charging controller 112 or the USB-PD controller 122. The system 500 may include a peripheral subsystem 502 that includes a number of components for use in wireless charging or USB power delivery.

The peripheral subsystem 502 may include a peripheral interconnect 504 including a peripheral clock module (PCLK) 506 for providing clock signals to the various components of the peripheral subsystem 502. The peripheral interconnect 504 may be a peripheral bus, such as a single level or Multi-level Advanced High Performance Bus (AHB), and can provide a data and control interface between the peripheral subsystem 502, a CPU subsystem 508, and system resources 510. The peripheral interconnect 504 may include controller circuitry, such as direct memory access (DMA) controllers, which may be programmed to transfer data between peripheral blocks without input from the CPU subsystem 508, without control of the CPU subsystem 508, or without stressing the same transfer.

The peripheral interconnect 504 may be used to couple the peripheral subsystem 502 components to other components of the system 500. A number of general purpose inputs/outputs (GPIOs) 512 may be coupled to the peripheral interconnect 504 for sending and receiving signals. The GPIOs 512 may include circuitry configured to implement various functions such as pull-up, pull-down, input threshold selection, input and output buffer enable/disable, single multiplexing, and so on. Other functions can also be implemented by the GPIOs 512. One or more timer/counter/pulse width modulators (TCPWM) 514 may also be coupled to the peripheral interconnect and may include circuitry to implement timing circuits (timers), counters, pulse width modulators (PWMs), decoders, and other digital functions associated with I/O signals work and can provide digital signals for system components of the system 500. The peripheral subsystem 502 may also include one or more Serial Communication Blocks (SCBs) 516 for implementing serial communication interfaces such as I2C, Serial Peripheral Interface (SPI), Universal Asynchronous Receiver/Transmitter (UART), Controller Area Network (CAN), CXPI (Clock Extension Peripheral Interface), etc.

The peripheral subsystem 502 may include a charging subsystem 518 (e.g., for USB-PD or wireless charging) coupled to the peripheral interconnect 504 and including a set of modules 520. The modules 520 may be coupled to the peripheral interconnect 504 by a charging interconnect 522. The modules 520 may include: an analog-to-digital converter (ADC) module for converting various analog signals into digital signals; an error amplifier (AMP) that regulates the output voltage on the VBUS line by PD contract; a high voltage (HV) regulator for converting the power source voltage to a precise voltage (such as 3.5-5V) to power the system 500; a low-side current sense amplifier (LSCSA) to accurately measure load current, an over-voltage protection (OVP) module and an over-current protection (OCP) module to provide over-current and over-voltage protection on the VBUS line with configurable thresholds and response times; one or more gate drivers for external power field effect transistors (FETs) (e.g., in the voltage regulator circuits 114, 124) in provider and consumer configurations; and a communications channel PHY module to support communications on a communication channel line (e.g., a USB Type-C communications channel (CC) line). The modules 520 may also include a charger detection module to determine if charging circuitry is present and coupled to the system 500 and a VBUS discharge module to control the discharge of voltage on the VBUS. The VBUS discharge module may be configured to couple to a power source node on the VBUS line or to an output (power sink) node on the VBUS line and adjust the voltage on the VBUS line to the desired voltage level (i.e., the voltage level specified in the contract negotiated voltage level). The power delivery subsystem 518 may also include pads 524 for external connections and Electrostatic Discharge (ESD) suppression circuitry 526. The modules 520 may also include a communication module for retrieving and transmitting information, such as control signals.

The GPIOs 512, the TCPWM 514, and the SCB 516 may be coupled to an input/output (I/O) subsystem 528, which may include a high-speed (HS) I/O matrix 530 connected to a number of GPIOs 532. The GPIOs 512, the TCPWM 514, and the SCB 516 may be coupled to the GPIOs 532 through the HS-I/O matrix 530.

The central processing unit (CPU) subsystem 508 is provided for processing instructions, storing program information and data. The CPU subsystem 508 may include one or more processing units 534 for executing instructions and reading from and writing to memory locations from a number of memories. The processing unit 534 may be a processor suitable for operation in an integrated circuit (IC) or system-on-chip (SOC) device. In some embodiments, the processing unit 534 may be optimized for low power operation with extensive clock gating. In this embodiment, different internal control circuits can be implemented for processing unit operation in different power states. For example, the processing unit 534 may include a single wire debug (SWD) module, a terminal count (TC) module, a wake-up interrupt controller (WIC) configured to wake up the processing unit from a sleep state, which may shut down power when the IC or SOC is in is in a sleep state, a fast multiplier, a nested vector interrupt controller (NVIC), and an interrupt multiplexer (IRQMUX). The CPU subsystem 508 may include one or more memories, including a flash memory 536, a static random access memory (SRAM) 538, and a read only memory (ROM) 540. The flash memory 536 may be non-volatile memory (NAND flash, NOR flash, etc.) configured to store data, programs, and/or other firmware instructions. The flash memory 536 may include system performance controller interface (SPCIF) registers and a read accelerator and, by being integrated into the CPU subsystem 508, improve access times. The SRAM 538 may be volatile memory configured to store data and firmware instructions accessible by the processing unit 534. The ROM 540 may be configured to store boot routines, configuration parameters, and other firmware parameters and settings that do not change during operation of the system 500. The SRAM 538 and the ROM 540 may have associated control circuitry. The processing unit 534 and the memory modules 536, 538, 540 may be coupled to a system interconnect 542 to route signals to and from the various components of the CPU subsystem 508 to other blocks or modules of the system 500. The system interconnect 542 can be implemented as a system bus, such as a single-level or multi-level AHB. The system interconnect 542 may be configured as an interface to couple the various components of the CPU subsystem 508 together. The system interconnect 542 may be coupled to the peripheral interconnect 504 to provide signal paths between the CPU subsystem 508 and components of the peripheral subsystem 502.

The system resources 510 may include a power module 544, a clock module 546, a reset module 548, and a test module 550. The power module 544 may include a sleep control module, a wake-up interrupt control (WIC) module, a power-on-reset (POR) module, a number of voltage references (REF), and a PWRSYS module. In some embodiments, the power module 544 may include circuitry that allows the system 500 to draw power from and/or provide power to external sources at different voltage and/or current levels and control operation in different power states, such as active, low power, or sleep. In various embodiments, more power states may be implemented as the system 500 throttles operation to achieve a desired power consumption or power output. The clock module 546 may include a clock control module, a watchdog timer (WDT), an internal low-speed oscillator (ILO), and an internal main oscillator (IMO). The reset module 548 may include a reset control module and an external reset module (XRES module). The test module 550 may include a module to control and enter a test mode, as well as test control modules for analog and digital functions (digital test and analog DFT).

The system 500 may be implemented as an IC controller (e.g., such as wireless charging controller 112 or a USB-PD controller 122) in a monolithic (e.g., single) semiconductor die. In other embodiments, different parts or modules of the system 500 may be implemented on different semiconductor dies. For example, the memory modules 536, 538, 540 of the CPU subsystem 508 may be on-chip or off-chip. In still other embodiments, circuitry with separate dies can be packaged in a single “chip” or remain separate and arranged on a circuit board (or in a USB cable connector) as separate elements.

The system 500 can be implemented in a number of application contexts. In any application context, an electronic device may have an IC controller or SOC implementation embodied by the system 500 arranged and configured to perform operations according to the techniques described herein (e.g., such as wireless charging controller 112 or a USB-PD controller 122). In one embodiment, the system 500 may be arranged and configured in a personal computer (PC) power adapter for a laptop, notebook computer, and so on. In an embodiment, the system 500 may be housed in a power adapter for a mobile electronic device (e.g. a smartphone, a tablet, etc.). In an embodiment, the system 500 may be arranged and configured in a car charger configured to provide power via a wireless charging pad and USB Type-A and/or Type-C port(s). In an embodiment, the system 500 may be arranged and configured in a power bank that can be charged via a USB Type-A and/or Type-C port and then provide power (e.g., wirelessly or via a USB port) to another electronic device.

It should be understood that a system, such as the system 500, implemented on or as an IC controller, can be placed in various applications that vary in terms of the type of power source used and the direction in which power is supplied. For example, in the case of a car charger, the power source is a car battery that provides DC power, while in the case of a mobile power adapter, the power source is an AC wall outlet. Further, in the case of a PC power adapter, the flow of power input is from a provider device to a consumer device, while in the case of a power bank, the flow of power input can be in either direction, depending on whether the power bank is operating as a power provider (e.g., to power another device) or as a power consumer (e.g., to allow itself to be charged). For these reasons, the various applications of the system 500 should be considered in an illustrative rather than a limiting sense.

In an embodiment of the techniques presented herein, a charging system comprises an input port, a wireless charging unit, comprising a magnetic charging interface, and a wireless charging controller configured to generate a magnetic charging signal at the magnetic charging interface based on a first connection state of the magnetic charging interface, and a universal serial bus power delivery (USB-PD) power adaptor, comprising an output port, and a USB-PD controller configured to deliver power to the output port, wherein a first portion of available power at the input port is allocated to the wireless charging unit for generating the magnetic charging signal responsive to the first connection state indicating a connected device, and a second portion of the available power at the input port is allocated to the USB-PD adaptor based on the first portion allocated to the wireless charging unit.

In an embodiment of the techniques presented herein, the charging system comprises a communication bus connecting the wireless charging controller and the USB-PD controller, wherein the wireless charging controller is configured to determine the second portion of the available power based on the available power at the input port and the first portion, and communicate the second portion of the available power to the USB-PD controller using the communication bus.

In an embodiment of the techniques presented herein, the wireless charging controller is configured to communicate a power delivery profile generated based on the second portion of the available power to the USB-PD controller.

In an embodiment of the techniques presented herein, the USB-PD controller is configured to generate a power delivery profile based on the second portion of the available power.

In an embodiment of the techniques presented herein, the USB-PD controller is configured to establish a contract for delivering the power to the output port responsive to a second connection state indicating a connected device based on a power delivery profile generated based on the second portion of the available power.

In an embodiment of the techniques presented herein, the USB-PD controller is configured to communicate a requested voltage associated with the contract to the wireless charging controller.

In an embodiment of the techniques presented herein, the USB-PD power adaptor comprises a voltage regulator circuit, and a bypass circuit configured to connect the input port to the output port, wherein the USB-PD controller is configured to enable the bypass circuit responsive to the requested voltage matching a voltage at the input port, and enable the voltage regulator circuit to generate the requested voltage responsive to the requested voltage being less than the voltage at the input port.

In an embodiment of the techniques presented herein, the wireless charging unit comprises a voltage regulator circuit, a coil circuit configured to generate the magnetic charging signal at the magnetic charging interface, and an inverter circuit connected between the voltage regulator circuit and the coil circuit to power the coil circuit, wherein the wireless charging controller is configured to control the voltage regulator circuit to step down a voltage at the input port to power the inverter circuit.

In an embodiment of the techniques presented herein, a method for operating a charging system comprises receiving a power supply signal at an input port, generating a magnetic charging signal at a magnetic charging interface based on a first connection state of the magnetic charging interface, delivering power to a universal serial bus (USB) output port, allocating a first portion of available power at the input port for generating the magnetic charging signal responsive to the first connection state indicating a connected device, wherein the available power at the input port is a function of the power supply signal, and allocating a second portion of the available power at the input port for delivering the power to the USB output port based on the first portion allocated for generating the magnetic charging signal.

In an embodiment of the techniques presented herein, the method comprises determining the second portion of the available power based on the available power at the input port and the first portion, and communicating the second portion of the available power to a universal serial bus power delivery (USB-PD) controller configured to deliver power to the USB output port over a communication bus.

In an embodiment of the techniques presented herein, the method comprises communicating a power delivery profile generated based on the second portion of the available power to the USB-PD controller over the communication bus.

In an embodiment of the techniques presented herein, the method comprises establishing a contract for delivering the power to the USB output port responsive to a second connection state indicating a connected device based on a power delivery profile generated based on the second portion of the available power.

In an embodiment of the techniques presented herein, the method comprises communicating a requested voltage associated with the contract to a wireless charging controller configured to generate the magnetic charging signal.

In an embodiment of the techniques presented herein, the method comprises enabling a bypass circuit connecting the input port to the USB output port responsive to the requested voltage matching a voltage at the input port, and enabling a voltage regulator circuit connected to the input port to generate the requested voltage for delivering the power to the USB output port responsive to the requested voltage being less than the voltage at the input port.

In an embodiment of the techniques presented herein, the method comprises generating the magnetic charging signal in a coil circuit, powering the coil circuit using an inverter circuit, and controlling a voltage regulator circuit to step down the voltage at the input port to power the inverter circuit.

In an embodiment of the techniques presented herein, a charging system comprises an input port, a wireless charging unit, comprising a magnetic charging interface, and a wireless charging controller configured to generate a magnetic charging signal at the magnetic charging interface based on a first contract, and a universal serial bus power delivery (USB-PD) power adaptor, comprising an output port, and a USB-PD controller configured to deliver power to the output port based on a second contract, wherein one of the wireless charging controller or USB-PD controller is designated as a primary controller and the other of the wireless charging controller or USB-PD controller is designated as a secondary controller, the primary controller is configured to generate a power delivery profile for the USB-PD controller based on available power at the input port and power used by the wireless charging unit to generate the magnetic charging signal according to the first contract, and the secondary controller is configured send an interrupt signal to the primary controller responsive to a change in a connection state associated with the secondary controller.

In an embodiment of the techniques presented herein, the USB-PD controller is configured to communicate a requested voltage associated with the second contract to the wireless charging controller.

In an embodiment of the techniques presented herein, the USB-PD power adaptor comprises a voltage regulator circuit, and a bypass circuit configured to connect the input port to the output port, wherein the USB-PD controller is configured to enable the bypass circuit responsive to the requested voltage matching a voltage at the input port, and enable the voltage regulator circuit to generate the requested voltage responsive to the requested voltage being less than the voltage at the input port.

In an embodiment of the techniques presented herein, the wireless charging controller is configured to communicate the requested voltage to a power source powering the input port.

In an embodiment of the techniques presented herein, the wireless charging unit comprises a voltage regulator circuit, a coil circuit configured to generate the magnetic charging signal at the magnetic charging interface, and an inverter circuit connected between the voltage regulator circuit and the coil circuit to power the coil circuit, wherein the wireless charging controller is configured to control the voltage regulator circuit to step down a voltage at the input port to power the inverter circuit.

Various operations of embodiments are provided herein. In an embodiment, one or more of the operations described may constitute computer readable instructions stored on one or more computer readable media, which if executed by an electronic device, will cause the device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application can generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A charging system, comprising:
an input port;
a wireless charging unit, comprising:
a magnetic charging interface; and
a wireless charging controller configured to generate a magnetic charging signal at the magnetic charging interface based on a first connection state of the magnetic charging interface; and
a universal serial bus power delivery (USB-PD) power adaptor, comprising:
an output port; and
a USB-PD controller configured to deliver power to the output port, wherein:
a first portion of available power at the input port is allocated to the wireless charging unit for generating the magnetic charging signal responsive to the first connection state indicating a connected device; and
a second portion of the available power at the input port is allocated to the USB-PD adaptor based on the first portion allocated to the wireless charging unit.

2. The charging system of claim 1, comprising:
a communication bus connecting the wireless charging controller and the USB-PD controller; wherein:
the wireless charging controller is configured to:
determine the second portion of the available power based on the available power at the input port and the first portion; and
communicate the second portion of the available power to the USB-PD controller using the communication bus.

3. The charging system of claim 1, wherein:
the wireless charging controller is configured to communicate a power delivery profile generated based on the second portion of the available power to the USB-PD controller.

4. The charging system of claim 1, wherein:
the USB-PD controller is configured to generate a power delivery profile based on the second portion of the available power.

5. The charging system of claim 1, wherein:
the USB-PD controller is configured to establish a contract for delivering the power to the output port responsive to a second connection state indicating a connected device based on a power delivery profile generated based on the second portion of the available power.

6. The charging system of claim 5, wherein:
the USB-PD controller is configured to communicate a requested voltage associated with the contract to the wireless charging controller.

7. The charging system of claim 6, wherein:
the USB-PD power adaptor comprises:
a voltage regulator circuit; and
a bypass circuit configured to connect the input port to the output port, wherein:
the USB-PD controller is configured to:
enable the bypass circuit responsive to the requested voltage matching a voltage at the input port; and
enable the voltage regulator circuit to generate the requested voltage responsive to the requested voltage being less than the voltage at the input port.

8. The charging system of claim 1, wherein:
the wireless charging unit comprises:
a voltage regulator circuit;
a coil circuit configured to generate the magnetic charging signal at the magnetic charging interface; and
an inverter circuit connected between the voltage regulator circuit and the coil circuit to power the coil circuit, wherein:
the wireless charging controller is configured to control the voltage regulator circuit to step down a voltage at the input port to power the inverter circuit.

9. A method for operating a charging system comprising:
receiving a power supply signal at an input port;
generating a magnetic charging signal at a magnetic charging interface based on a first connection state of the magnetic charging interface;
delivering power to a universal serial bus (USB) output port;
allocating a first portion of available power at the input port for generating the magnetic charging signal responsive to the first connection state indicating a connected device, wherein the available power at the input port is a function of the power supply signal; and
allocating a second portion of the available power at the input port for delivering the power to the USB output port based on the first portion allocated for generating the magnetic charging signal.

10. The method of claim 9, comprising:
determining the second portion of the available power based on the available power at the input port and the first portion; and
communicating the second portion of the available power to a universal serial bus power delivery (USB-PD) controller configured to deliver power to the USB output port over a communication bus.

11. The method of claim 10, comprising:
communicating a power delivery profile generated based on the second portion of the available power to the USB-PD controller over the communication bus.

12. The method of claim 9, comprising:
establishing a contract for delivering the power to the USB output port responsive to a second connection state indicating a connected device based on a power delivery profile generated based on the second portion of the available power.

13. The method of claim 12, comprising:
communicating a requested voltage associated with the contract to a wireless charging controller configured to generate the magnetic charging signal.

14. The method of claim 13, comprising:
enabling a bypass circuit connecting the input port to the USB output port responsive to the requested voltage matching a voltage at the input port; and
enabling a voltage regulator circuit connected to the input port to generate the requested voltage for delivering the power to the USB output port responsive to the requested voltage being less than the voltage at the input port.

15. The method of claim 13, comprising:
generating the magnetic charging signal in a coil circuit;
powering the coil circuit using an inverter circuit; and
controlling a voltage regulator circuit to step down the voltage at the input port to power the inverter circuit.

16. A charging system, comprising:
an input port;
a wireless charging unit, comprising:
a magnetic charging interface; and
a wireless charging controller configured to generate a magnetic charging signal at the magnetic charging interface based on a first contract; and
a universal serial bus power delivery (USB-PD) power adaptor, comprising:
an output port; and
a USB-PD controller configured to deliver power to the output port based on a second contract, wherein:
one of the wireless charging controller or USB-PD controller is designated as a primary controller and the other of the wireless charging controller or USB-PD controller is designated as a secondary controller;
the primary controller is configured to generate a power delivery profile for the USB-PD controller based on available power at the input port and power used by the wireless charging unit to generate the magnetic charging signal according to the first contract; and
the secondary controller is configured send an interrupt signal to the primary controller responsive to a change in a connection state associated with the secondary controller.

17. The charging system of claim 16, wherein:
the USB-PD controller is configured to communicate a requested voltage associated with the second contract to the wireless charging controller.

18. The charging system of claim 17, wherein:
the USB-PD power adaptor comprises:
a voltage regulator circuit; and
a bypass circuit configured to connect the input port to the output port, wherein:
the USB-PD controller is configured to:
enable the bypass circuit responsive to the requested voltage matching a voltage at the input port; and
enable the voltage regulator circuit to generate the requested voltage responsive to the requested voltage being less than the voltage at the input port.

19. The charging system of claim 17, wherein:
the wireless charging controller is configured to communicate the requested voltage to a power source powering the input port.

20. The charging system of claim 16, wherein:
the wireless charging unit comprises:
a voltage regulator circuit;
a coil circuit configured to generate the magnetic charging signal at the magnetic charging interface; and
an inverter circuit connected between the voltage regulator circuit and the coil circuit to power the coil circuit, wherein:
the wireless charging controller is configured to control the voltage regulator circuit to step down a voltage at the input port to power the inverter circuit.
